(19) United States
(12) Patent Application Publication
(10) Pub. No.: US 2009/0271269 A1
(43) Pub. Date: Oct. 29, 2009

(54) METHOD FOR INTEGRATING INTERACTIVE ADVERTISING INTO VISUAL CONTENT

(75) Inventors: Adam Lieb, San Francisco, CA (US); James Rose, San Francisco, CA (US)

Correspondence Address: Adam Lieb, 1323 6th Ave, San Francisco, CA, 94122, US

(73) Assignees: Adam Lieb, San Francisco, CA (US); James Rose, San Francisco, CA (US)

(21) Appl. No.: 12/428,609

(22) Filed: Apr. 23, 2009

Related U.S. Application Data
(60) Provisional application No. 61/047,226, filed on Apr. 23, 2008.

(51) Int. Cl. G06Q 30/00; G06F 3/048

(52) U.S. Cl. 705/14.52; 705/14.4; 705/27; 705/14.49; 715/822

(57) ABSTRACT

The present invention is a method and apparatus that relates to inserting contextual advertising into interactive visual content. The present invention provides a means to visually highlight elements within images, video, interactive applications and other visual content and then connect those elements to relevant content and messages from advertisers.

### CROSS-REFERENCE TO RELATED APPLICATIONS

None.

### FEDERALLY SPONSORED RESEARCH

None.

### SEQUENCE LISTING

None.

### FIELD OF THE INVENTION

The present invention relates to interactive advertising and publishing.

### BACKGROUND

Advertising is the primary means that many interactive publishers (“Interactive Publishers”) (such as website publishers, mobile content providers, interactive television services and other digital content providers) use to generate income. Interactive Publishers often will dedicate specific areas of each user interface (“Interface”) (such as web pages, application screens, interactive widgets, browser-based smartphone screens and other user interfaces) to advertising (“Ad Space”) and then display various types of advertising within these ad spaces, such as image-based ads (“Graphical Ad”), animated or immersive ads (“Interactive Ad”) and text-based ads (“Text Ad”). Interactive Publishers will often partner with third party ad networks (“Ad Networks”) that will display ads on their behalf within their Interfaces. These Ad Networks are generally responsible for negotiating with advertisers and targeting ads to Interfaces and Ad Spaces. Targeting is the act of selecting the ad that is most relevant to the content displayed on an Interface and the demographics of the viewer. By targeting an ad, the Ad Network or Interactive Publisher can improve the chance that the viewer will find the ad relevant to their interests and interact with the ad, which can ultimately increase the revenues for the Ad Network and Interactive Publisher.

One primary shortcoming of today's interactive advertising model is that viewers can very quickly learn to differentiate between advertisements and content, and then ignore the advertisements. This phenomenon is known ad “Ad Blindness”. When users become blind to the advertisements they are less likely to look at or click on advertisements or otherwise interact with ads, which reduces the value of that Ad Space for advertisers and Interactive Publishers. For example, in the late 1990's, horizontal Graphical Ads at the top or bottom of web pages were a popular advertising unit. However, the value of this particular advertising unit declined in popularity as advertisers learned that viewers were much less likely to notice and interact with this type of ad. In the case of Internet websites advertisers often pay on a click rate basis (i.e. Percentage of page views on which generated a click), or evaluate the effectiveness of their ads on a per-click basis, and as a result advertisers will pay a higher rate for better performing ads. Therefore, techniques which can make advertising more noticeable to a viewer will increase the value and revenue potential of each page view.

A secondary shortcoming of the current advertising model is that many ad spaces are kept separate from the associated content. This makes it difficult for the Ad Networks to articulate specific relationships or connections between the content of the page and the advertisement, especially for graphical content. For example, an Interface may be displaying an image of a celebrity, and an Ad Network displays an advertisement featuring the shoes that the celebrity is wearing in the image. However, since the advertisement is located in a separate space on the Interface, it may not be clear to the viewer what the relationship is between a specific object in the image and the advertisement. This lack of clarity means that that viewer is less likely to understand the purposes of the ad, and thus reduces the potential revenue.

Therefore, new techniques which can better integrate ads within interactive content, and better connect ads to visual content are of high value to advertisers, Interactive Publishers, and Ad Networks.

### SUMMARY

The present invention is a method and apparatus to provide a means for a third party ad publisher (“Ad Publisher’) to visually highlight specific items within visual content and integrate advertisements directly within the Interface's main content stream. These advertisements may be directly related to the highlighted elements and can be display on top of or along side of the content.

### DRAWINGS

FIG. 1 is an example of an original image 1. The image contains two objects 2 and 3, which depict specific objects.

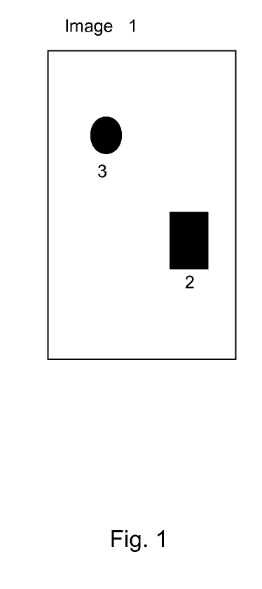

FIG. 2 shows highlight markings overlayed onto the image. 5 is an example of an icon marking object 2. 4 is an example of an outline marking around object 2.

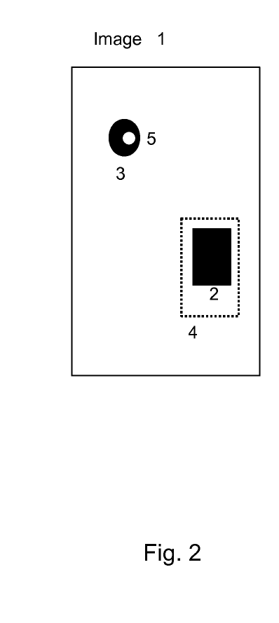

FIG. 3 shows the ad window 7 which is displayed when the user's mouse passes over the marking 4.

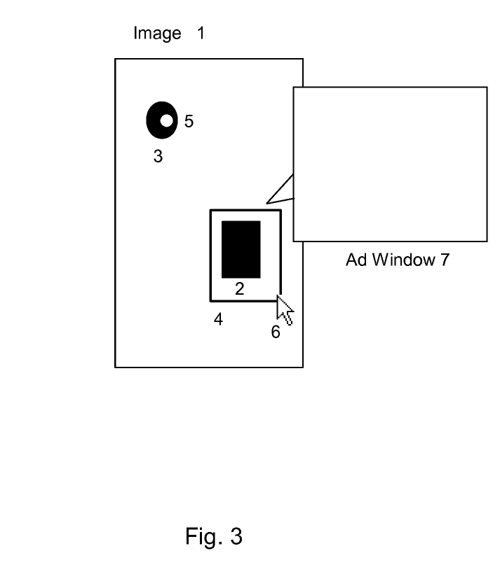

FIG. 4 shows the interaction of the parties involved. The interactive publisher 200 makes content available to the controller 210. The controller, possibly with the assistance of the operator 230, decides which objects to highlight and what advertising content to display. When the end user 220 views the content from the interactive publisher, the end user also retrieves data from the controller to enable the advertising code to display the overlays and ad windows.

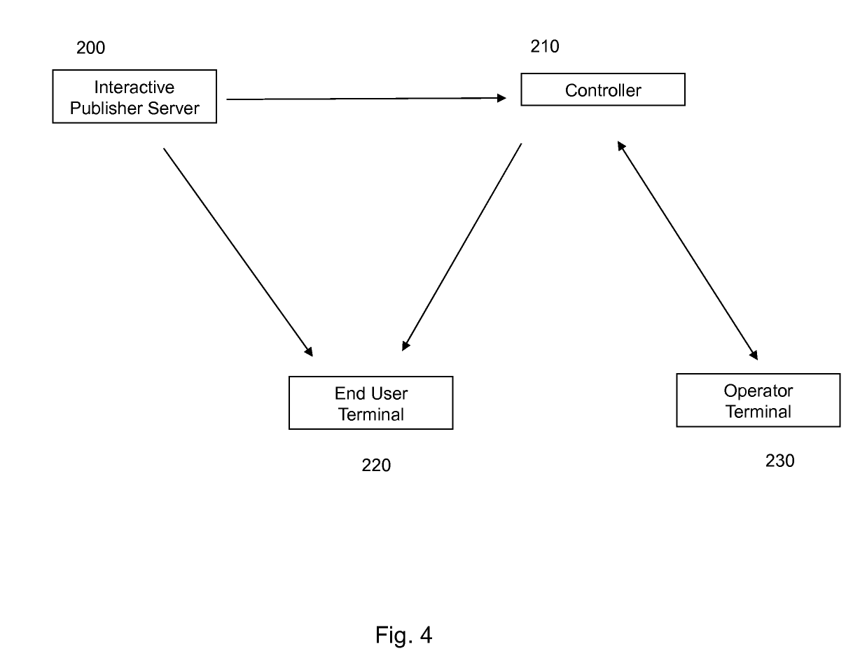

FIG. 5 shows the operation of the advertising code. The code is first inserted into the interface either by the publisher 310, end-user 320, or embedded directly into the content 330. The code then downloads or accesses the advertisements relating to the content the end-user is currently viewing 340. It then displays these advertisements 350 through overlays or via ad windows. The users actions, which as clicking on an overlay marking or opening an ad window, can be communicated back from the end-user to the controller or publisher.

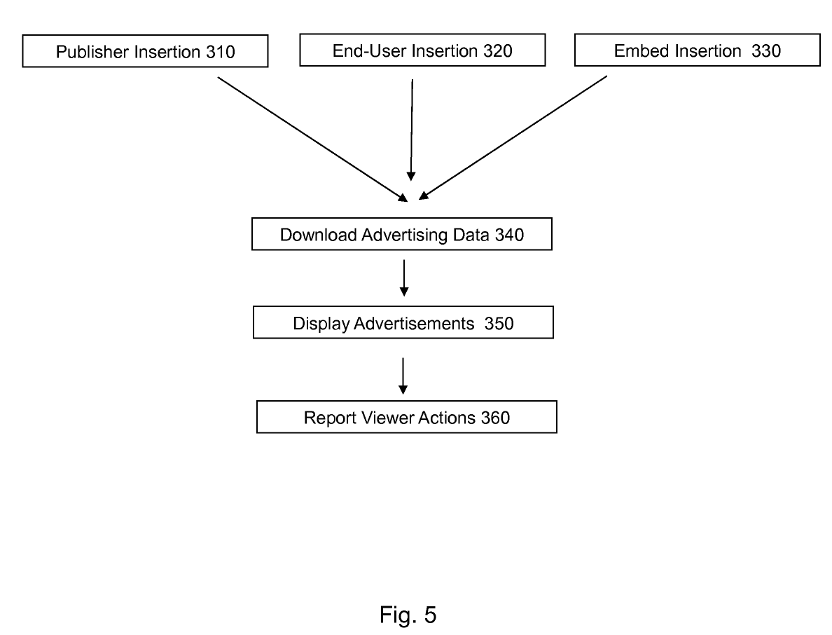

### OPERATION

### Client-Side Code Integration

The first step is to insert the ad technology into an Interface. There are 3 ways in which this can be accomplished.

1. Interactive Publisher Insertion—In this method, an Interactive Publisher includes a simple code within their Interfaces. This insertion can require minimal effort on the behalf of the Interactive Publisher. The code may be written in javascript or other languages. When a viewer opens the Interface, the viewer's client interprets the code and connects to the controller (“Controller”—such as a server running software to manage and serve advertising) to identify which Interface the viewer is currently viewing and to, optionally, download additional code from the Controller.

2. End-User Insertion—In this method, an end user chooses to download code which modifies their client Interface. Then, whenever the user visits a pre-defined list of Interfaces, the ad insertion code is added to the page. The code then connects to the Controller as per above.

3. Embed Insertion—In this method, a Interactive Publisher can include specific “wrapped” content on their Interfaces by adding code to reference an embeddable application, which may be, for example, a Flash brand application. This application loads the content and then overlays the advertisement. When using the method, a publisher needs to add “wrapped” content on a case-by-case basis.

Once installed, the code (“Client-Side Code”) can operate in a similar fashion for all 3 insertion methods.

### Downloading the Advertisement Data

The Client-Side Code then needs to retrieve a list of advertisements from the Controller that correspond with the visual content appearing on the current Interface. These advertisements can be predetermined automatically by computer algorithms. Or, these advertisements can be selected by human operators, who visually inspect the visual content, and choose appropriate advertisements from advertising partners based on the products that appear in the visual content. Or, the operators may choose advertisements based on the people appearing in the content, for example the types of clothes they are wearing, the setting, or any other visual attributes of the visual content which the human operator believes will make the advertisement more relevant. In the event that a human operator has not yet chosen one or more advertisements for each visual content piece or chooses not to, the Controller can decide to automatically select advertisements, based on the text on the interface, the text near the visual content, the web site, prior connections between similar visual content and advertisers created by human operators, and/or the ads which generally have the highest value.

The Client-Side Code must access the data that defines these advertisements. In one instance, the data defining these advertisements may be written directly into the Client-Side Code. In another instance, the Client-Side Code may separately download the advertising data from the Controller using an additional request. In either instance, the advertising data identifies which visual content should contain advertising using a list of Unique Identifiers (“Unique Identifiers”) (for example, a url), the specific areas of the visual content which should be highlighted or linked, and any additional advertising content the corresponds to those areas, such as product names, prices, descriptions, promotional images or animations, and the advertiser's identifier (such as website address).

### Displaying the Advertisement

Once the Client-Side Code has accessed the data, the code can then display the advertisements. The Client-side Code first locates the visual content on the page using the Unique Identifiers. Once the visual content has been located, the Client-side Code can visually highlight the elements within the content using one of several methods. The Client-side Code can draw a shape to outline the element. Or, the Client-side Code can overlay an icon on top of the content. Or, the Client-Side Code can display the name of the element or photo that corresponds to the element, and then optionally draw an arrow or other indicator to where the element is positioned in the visual content. These markings can blink, change colors or border, or otherwise animate to help draw the viewer's attention.

When the viewer interacts with these markings, the code can optionally display additional information corresponding to the object within an overlay or expanded area (“Ad Window”). The Ad Window can contain an item name, photo, price, description, information on the designer, retailer, or manufacturer, or other information that may be relevant to the highlighted element. This information may correspond to the exact item displayed, similar items to the one displayed, or non-item information such as relevant services which correspond to the image or element. Each Ad Window may contain information about multiple products or services. The viewer can then close the Ad Window manually, or the Client-Side Code can close the Ad Window automatically when the viewer moves to another part of the Interface. The Ad Window can also be added directly to the Interface, so that it's always visible and does not need to be trigged by an action by the viewer.

### Reporting Viewer's Actions

When the viewer opens an Ad Window, the Client-Side Code can report this action back to the Controller. When the viewer clicks on the image highlights or clicks on any links or buttons within the Ad Window, the viewer can then directed to the advertiser's desired location, for example a website. The Client-side Code can report this click to the Controller using a standard HTTP redirect or by otherwise communicating the click to the Controller before the viewer is directed to the advertiser's location. Optionally, the advertiser can choose to place tracking code on advertiser's site to report to the Controller (or can otherwise report) when a viewer referred by the Controller has made a purchase or performed a desired action. Using this data, the Controller can charge advertisers on a per-click, per-action, per Interface impression, or per-impression of the Ad Window. Also, the Controller can use this data to gauge the effectiveness of each advertisement, and use it when deciding which advertisements to display.

Although the description above contains many specifics, these should not be construed as limiting the scope of the method but merely providing illustrations of some of the presently preferred embodiments of this method. Thus the scope of the method should be determined by the appended claims and their legal equivalents, rather than by the examples given.

1. An advertising system, comprising:
images; and
advertising code;
where in the system is to:
overlay highlight markings on top of specific elements within the images

2. The method of claim 1, further comprising:
The advertising code is hosted by the publisher of the images

3. The method of claim 1, further comprising:
The advertising code is hosted by an ad hosting service

4. The method of claim 1, further comprising:
An interactive publisher integrates the advertising code into their interface

5. The method of claim 1, further comprising:
An interactive publisher adds content to their interface which contains both images and advertising code

6. The method of claim 1, further comprising:
A user integrates advertising code into the interactive publisher's interface

7. The method of claim 1, further comprising:
The highlight markings includes a shape outlining an element in the image

8. The method of claim 1, further comprising:
The highlight markings includes an icon marking the element in the image

9. The method of claim 1, further comprising:
The highlight markings includes an arrow marking the element in the image

10. The method of claim 1, further comprising:
The highlight markings includes the name of the product represented by the element in the image

11. The method of claim 1, further comprising:
The highlight markings includes the price of the product represented by the element in the image

12. The method of claim 1, further comprising:
When a user clicks on the highlight markings, the ad codes directs the user to an interface from which they can purchase the item represented

13. The method of claim 1, further comprising:
Displaying an advertising window when a user's input device interacts with the highlight markings

14. The method of claim 13, further comprising:
The advertising window contains the item name, photo, price, description, designer, retailer, or manufacturer

15. The method of claim 13, further comprising:
The advertising window references the exact item displayed in the content

16. The method of claim 13, further comprising:
The advertising window references a similar item to the one displayed in the content

17. The method of claim 13, further comprising:
When the user clicks a user interface element in the ad window, the user is directed to a interface from which they can purchase the item represented

18. The method of claim 13, further comprising:
The ad code records data associated with displays of the ad window

19. The method of claim 1, further comprising:
The ad code records data associated with user clicks

20. The method of claim 1, further comprising:
The advertisements are chosen by a computer algorithm

21. The method of claim 1, further comprising:
The advertisements are chosen by human operators

22. The method of claim 1, further comprising:
Where the ad code contains data which defines the advertisements

23. The method of claim 1, further comprising:
The ad code separately retrieves data which defines the advertisements
